(19) United States
(12) Patent Application Publication
(10) Pub. No.: US 2013/0154232 A1
(43) Pub. Date: Jun. 20, 2013

(54) WHEELCHAIR

(71) Applicants: Narayanan RAMACHANDRAN, Bangalore (IN); Aruna ANANDKUMAR, Bangalore (IN)

(72) Inventors: Narayanan RAMACHANDRAN, Bangalore (IN); Aruna ANANDKUMAR, Bangalore (IN)

(21) Appl. No.: 13/369,776

(22) Filed: Feb. 9, 2012

(30) Foreign Application Priority Data
Dec. 20, 2011 (IN) 4458/CHE/2011

(51) Int. Cl. A61G 5/02

(52) U.S. Cl. 280/250.1

(57) ABSTRACT

A wheelchair for transportation of disabled includes a chassis and a plurality of wheels fixed to either end of chassis. At least one vertical support member is mounted at a predetermined location on the chassis to support a plurality of tubular fixator. A seat is joined to the tubular fixator which is pivoted onto the vertical support member and a plurality of friction knobs are provided on the tubular fixator to lock the horizontal and vertical movement of tubular fixator.

### TECHNICAL FIELD

Embodiments of the present disclosure relates to a wheelchair, more particularly the embodiments relates to wheelchair for paraplegics, which can be used by the disabled user who use hands to transfer themselves without the help of attendants.

### BACKGROUND OF INVENTION

A wheelchair is a chair with wheels, designed to be a replacement for walking. The device comes in variations where it is propelled by motors or manually by the seated occupant turning the rear wheels by hand. Wheelchairs are used by people for whom walking is difficult or impossible due to illness (physiological or physical), injury, or disability. There are about 500 million disabled people in the world. 100 Million people cannot walk and need a wheelchair. National data estimate that between 1.6 and 2.2 million Americans rely on wheelchairs to assist with mobility impairments.

Conventionally wheelchairs are well known, they have particular application to users who are disabled or have weak legs and cannot walk, and they need the help of assistants to transfer them from bed to chair and move them around.

The limitation of conventional wheel chairs is that paraplegic and disabled users cannot get on the wheelchair from their bed without help of attendant even though their hands are normal. Transfer from wheelchair to another chair or sofa or car or aircraft chair needs help. Help is required for transfer from wheel chair to commode in toilet.

Various devices have been designed in the past, as can be found in U.S. Pat. No. 3,993,349 which discloses a U-shaped frame structure of relatively light material which can be utilized as a support for an invalid while walking, to partially surround the invalid. It also includes single structure which can be utilized as a back support for a patient or invalid when seated on a structure such as the edge of the hospital bed. The back or seat single structure includes a sling member and support arms and on the frame structure specific mounting means are provided where the sling can be converted either from a backrest to a seat or vice versa.

U.S. Pat. No. 3,999,778 discloses a U-shape shaped frame with a column swing ably attached to the intermediate part of the U-shaped frame. A caster wheel is attached to the distal end of the column and a tube is swing ably attached to the distal ends of the U-shaped frame. A pair of brackets is provided by attaching the front side of the wheel chair to the brackets. Each of the brackets has a telescoping pin. Clamps are provided on the tubular brackets which can be attached to the wheel chair and which receive the telescoping pins attached to the U-shaped frame.

U.S. Pat. No. 4,934,723 discloses a device and method that will safely elevate a wheel chair to a greater height, hold the wheel chair in a safe elevated position and allow a person confined to the wheel chair to achieve the height of that of a standing person. The feet of the wheel chair are first rotated outward and lowered onto the floor, the wheel chair is then elevated by air pressure to a desired height and locked off for safety. When the wheel chair is being elevated or lowered, it will automatically lock off if the chair becomes unlevel for any reason.

U.S. Pat. No. 5,096,008 a rotatable stand-up wheelchair or invalid mobility device which includes a main drive chassis having front and rear wheels. A means for raising and lowering the seat and back portion of the wheelchair raises and lowers the invalid from a substantially seated position on the seat to a substantially standing position supported by a foot plate attached to the base of the wheelchair. Stability of the wheelchair device is maintained by two triangular wheel configurations intercepting at their apex. In operation, the invalid can move while standing in such a fashion as the foot plate may be lowered to a close proximity to the ground so that the invalids hand approximates the level of a hand height of a non-handicapped person. This simulated normal motion and enables direct contact with countertops and other work surfaces.

U.S. Pat. No. 5,460,394 discloses an invalid transport cart includes a pair of spaced-apart wheeled base rails, vertical posts extending there from, a brace extending between the rails and posts, a padded seat extending between the posts above the brace and sloped towards the front of the cart, and a horizontal grip bar extending from one of the vertical posts.

U.S. Pat. No. 5,884,929 discloses a wheelchair construction is disclosed for facilitating transfer of a person to and from the wheelchair. The wheelchair includes a mobile frame, a chair assembly for supporting a person in a sitting position, and mechanism shift ably supporting the chair assembly on the frame. The mechanism supports the chair assembly for movement between a transport position, in which the chair assembly is positioned generally over the frame, and a transfer position, in which the chair assembly is positioned laterally outwardly from the frame.

U.S. Pat. No. 6,325,399 discloses a lift wheelchair having a slide assembly seat support mechanism is disclosed. An extension element or cylinder is used to force a seat-supporting slide assembly upwardly and outward from the wheelchair frame. Stabilizing means are employed to accommodate the shifting centre of gravity of the wheelchair-occupant system, and arms on the seat may be pivoted to create a transfer-assisting bed-board or slide. One or more lift arms may be used to transfer the force from the extension element to the slide assembly and to provide load bearing support and seat stabilization for the wheelchair assembly.

U.S. Pat. No. 6,934,980 discloses a system to facilitate the transfer of a patient between a chair and a bed or other device. The system includes a chair and a transfer bridge interchangeably securable to either side of the chair. The top surface of the transfer bridge is positioned at substantially the same height as the seat to allow a patient to slide across the transfer bridge between the chair and bed. The system may also include an overhead canopy to provide patient support and to provide a surface to which various medical apparatus can be attached. The seat of the chair may also provide access to a bedpan positioned therein.

All of the above disclosed patent applications suffer from one or more disadvantages listed below
1. The apparatus requires help of assistants.
2. The apparatus is very costly and bulky
3. The apparatus is risky for use by the disabled
4. The apparatus is not portable
5. The apparatus does not have the freedom and ease of movement and maneuverability of compact wheel chairs and cannot be used in the homes of paraplegics.

Although the prior art discloses wheelchairs that are capable of raising the seat, helps user to rise to standing position, and seats which can move on a track, there is still need for a wheelchair which enables paraplegics to transfer from bed to wheelchair, from wheelchair to bed, from wheelchair to sofa or another chair or car or dental chair and use commode all by himself without the help of assistant.

In light of foregoing discussion it is necessary to develop a wheelchair for paraplegics which is simple in construction, cost effective, easy maneuverability to overcome the problems stated above.

### OBJECTIVES OF INVENTION

The main objective of the present disclosure is to provide a wheelchair which particularly suits for paraplegics, which provides for easy and safe wheel chair transfer, enabling the disabled to do the transfer themselves without any help from attendant.

One objective of the present disclosure provides a wheel chair which has two half seats which can be brought under the buttocks of the user while user is sitting on the bed, and carry the user.

One objective of the present disclosure is to provide paraplegics wheel chair, that can be positioned over commode by himself enabling user to use commode just by removing small strips from chair seat which can be easily done even by a weak patient.

One objective of the present disclosure is to provide a wheelchair, which has seats which will move and slide along the bed horizontally, to position the seats under the buttocks of the disabled, for transferring user in a safe and comfortable manner without need for helper.

One objective of the present invention is to provide a wheelchair which will be motorized with conventional device, for movement of the wheel chair by weak patients.

### SUMMARY OF INVENTION

The shortcomings of the prior art are overcome and additional advantages are provided through the provision as claimed in the present disclosure.

Additional features and advantages are realized through the techniques of the present disclosure. Other embodiments and aspects of the disclosure are described in detail herein and are considered a part of the claimed disclosure.

In an embodiment of the disclosure, a wheelchair for transportation of disabled person is disclosed. Said wheelchair comprises a chassis, plurality of wheels fixed to either end of chassis. Atleast one vertical support member mounted at predetermined location on the chassis to support a plurality of tubular fixator. A seat is joined to the tubular fixator pivoted onto the vertical support member and friction knobs are provided on the tubular fixator to lock the horizontal and vertical movement of tubular fixator.

In one embodiment of the disclosure, wheels at one end of the chassis are caster wheels.

In one embodiment of the disclosure, wheels at other end of the chassis are driving wheels.

In one embodiment of the disclosure, atleast one brake assembly is connected to the chassis to stop movement and lock the wheelchair in a place.

In one embodiment of the disclosure, the vertical support member is provided with plurality of holes along its length to accommodate a locking pin to restrict sliding of the tubular fixator along the vertical support.

In one embodiment of the disclosure, tubular fixator and vertical support members are concentric tubes, and said tubular fixator rotates horizontally and moves vertically on the vertical support members.

In one embodiment of the disclosure, the seat has an opening partially covered by plurality of removable strips placed in slots provided in the chair seat.

In one embodiment of the disclosure, the atm rests are fixed to the chair seat for placing users arm.

In one embodiment of the disclosure, the seat comprises a back rest.

In one embodiment of the disclosure, plurality of handles are provided behind the backrest to push or pull the wheelchair by an attendant.

In one embodiment of the disclosure, footrests are provided to one end of chassis for resting user legs.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE ACCOMPANYING DRAWINGS

The features described in this disclosure are set forth with particularity in the appended claims. These features and attendant advantages will become apparent from consideration of the following detailed description, taken in conjunction with the accompanying drawings. One or more embodiments are now described, by way of example only, with reference to the accompanying drawings wherein like reference numerals represent like elements and in which:

FIG. 1. illustrates perspective view of the wheelchair for paraplegics, with two half chair seats in closed position.

FIG. 2. illustrates perspective view of the wheelchair for paraplegics, with one chair seat.

FIG. 3. illustrates side elevation view of wheelchair.

FIG. 4. illustrates a top view of the wheelchair, showing two half seats and strips in closed position.

FIG. 5. illustrates a top view of wheelchair, showing wheelchair seats positioned above the bed.

FIG. 6. illustrates a top view of wheelchair, showing two half seats and strips in open position.

FIG. 7. illustrates a top view of wheelchair, positioned above the commode.

FIG. 8. illustrates side elevation view of the wheelchair for paraplegics with four caster wheels used by attendant for wheel chair transfer of patient who cannot use patient's hands.

The figures depict embodiments of the disclosure for purposes of illustration only. One skilled in the art will readily recognize from the following description that alternative embodiments of the structures and methods illustrated herein may be employed without departing from the principles of the disclosure described herein.

### DETAILED DESCRIPTION

The foregoing has broadly outlined the features and technical advantages of the present disclosure in order that the detailed description of the disclosure that follows may be better understood. Additional features and advantages of the disclosure will be described hereinafter which form the subject of the claims of the disclosure. It should be appreciated by those skilled in the art that the conception and specific embodiment disclosed may be readily utilized as a basis for modifying or designing other structures for carrying out the same purposes of the present disclosure. It should also be realized by those skilled in the art that such equivalent constructions do not depart from the spirit and scope of the disclosure as set forth in the appended claims. The novel features which are believed to be characteristic of the disclosure, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present disclosure. It will be readily understood that the aspects of the present disclosure, as generally described herein, and illustrated in the figures, can be arranged, substituted, combined, and designed in a wide variety of different configurations, all of which are explicitly contemplated and make part of this disclosure.

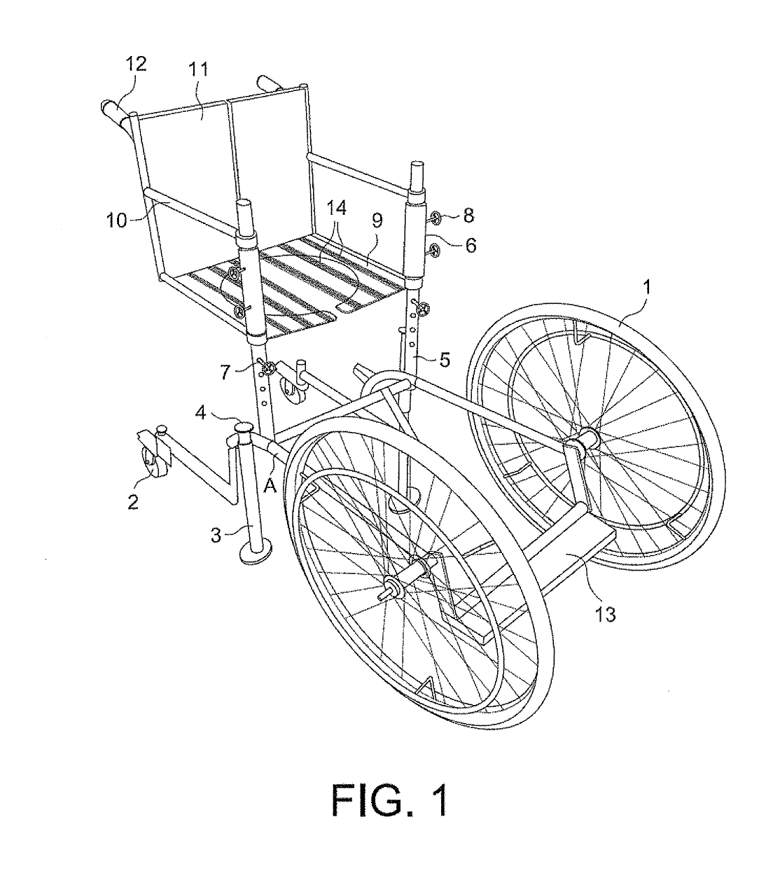

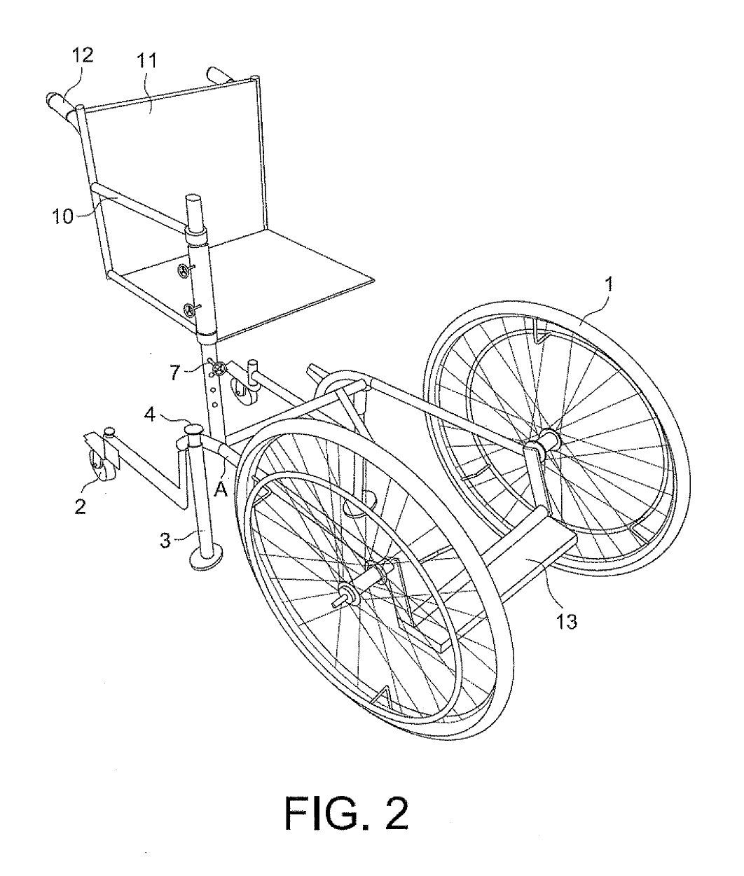

FIG. 1 is an exemplary embodiment of the disclosure illustrating a perspective view of the wheelchair for disabled persons. The wheelchair comprises, a chassis (A) attached with plurality of wheels at either ends. Wheels at one end of the chassis (A) are caster wheels (2) capable of rotating 360 degrees and wheels fixed to the other end of the chassis (A) are drive wheels (1) which are independently rotatable by hand by the user to move the wheelchair. One or more brake assembly (3) units having a brake handle (4) are attached to the opposite sides of the chassis (A) for stopping the movement of the wheelchair and to lock the wheelchair in place, by using the brake handle (4). Two vertical support members (5) are mounted on either sides of the chassis (A) at opposite ends to support a plurality of tubular fixator (6). In one aspect of the disclosure the only one vertical support member (5) can be used to support the tubular fixator (6) (as shown in FIG. 2). A tubular fixator (6) having slightly bigger diameter than the vertical support member (5) are concentrically placed. The tubular fixator (6) is pivoted onto the vertical support member (5) wherein, tubular fixator (6) is capable of sliding up and down on the vertical support member (5) and rotate horizontally on the vertical support member (5). In one aspect of the disclosure, the opening and closing of the seat, vertical movement, horizontal rotation of the seat, wheelchair driving motion can be done either by the means selected from a group comprising but not limited to manual means, mechanical means, electric means, pneumatic means or hydraulic means.

As a second embodiment of the present disclosure FIG. 2 illustrates a perspective view of the wheelchair having only one seat (9). A seat (9) is joined to the tubular fixator (6) which allows horizontal movement of the seat (9). Wherein, tubular fixator (6) is pivoted to the vertical support member (5) to facilitate the horizontal movement of the seat (9). In one aspect of the disclosure the vertical support member (5) is placed under the seat (9) away from the centre of the seat (9) in an off-centre position.

In one aspect of the disclosure the tubular fixator (6) is capable of sliding smoothly along the vertical support member (5) to adjust the height of the seat (9). Friction knobs (8) are provided on the tubular fixator (6) to prevent movement of the tubular fixator (6). When the friction knob (8) is turned by the user, the screw pin advances through the nut and through the hole and finally presses tightly against the vertical support member (5). This will prevent the movement of the tubular fixator (6) due to friction.

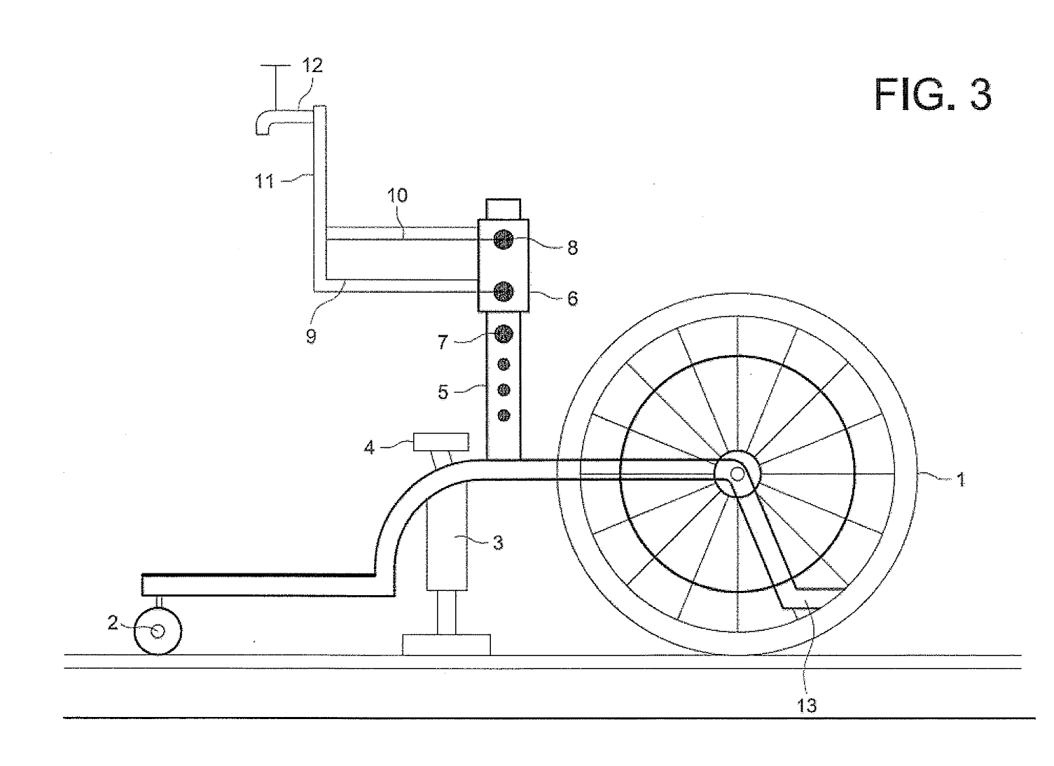

FIG. 3 is an exemplary embodiment which illustrates a side view of the wheelchair. Plurality of holes are provided along entire length of the vertical support member (5) to accommodate a locking pin (7). The holes on the circumference of the vertical support member (5) acts as receiving holes for the locking pins (7). The Locking pin (7) is passed through receiving holes of the vertical support member (5) to stop accidental sliding of the tubular fixator (6) under weight of the user. Several receiving holes are provided on the vertical support member (5) so that locking can be done at various heights as desired by the user. A seat (9) joined to the tubular fixator (6) has a backrest (11) attached to the seat (9) for supporting the back of the disabled person. Arm rests (10) are joined to the backrest (11) of the seat (9) which provides a means to rest the users arm. Handles (12) are joined to the backrest (11) of the seat (9) which enables the attendant to push or pull the wheelchair.

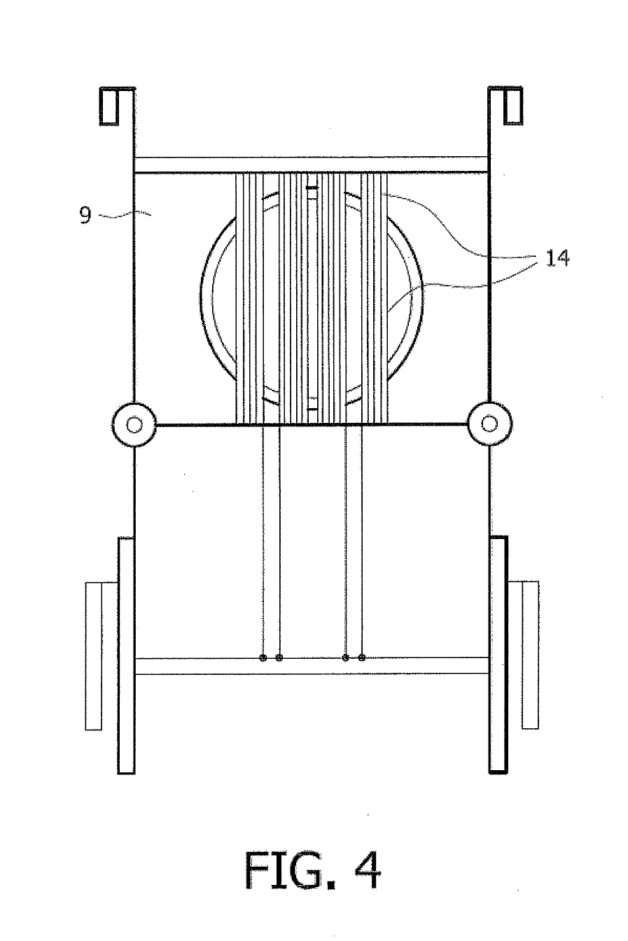

FIG. 4 is an exemplary embodiment which illustrates top view of the wheelchair. Two half seats (9) of the wheelchair are in closed position. Each half seat has a semicircular opening (15) partially covered by removable strips (14). When the half seats are in closed position the semicircular openings forms a circular opening (15). The removable strips (14) are inserted in slots provided on the seat (9) which can be removed to use the commode.

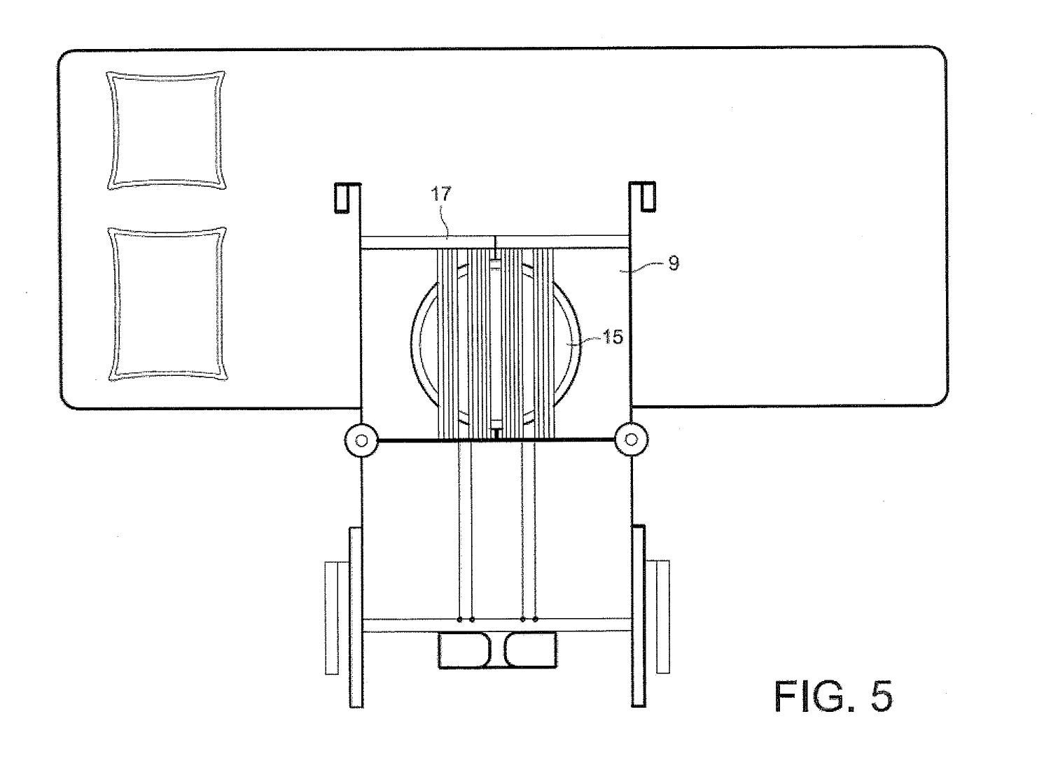

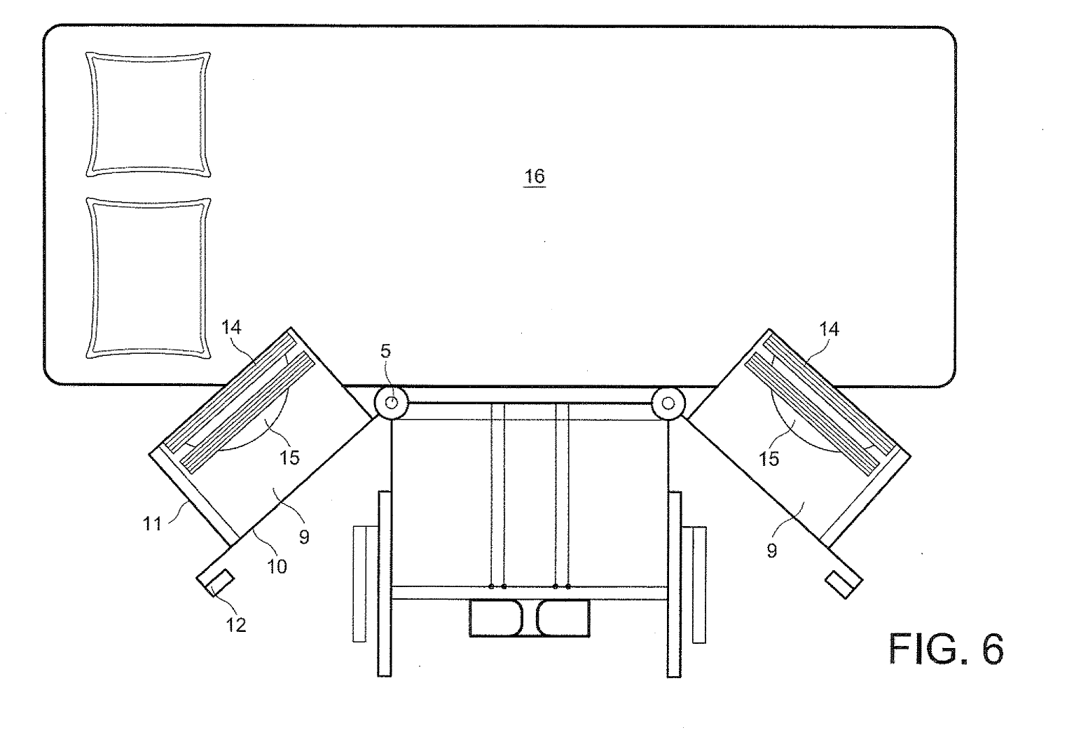

FIGS. 5 and 6 are exemplary embodiments illustrating a top view of wheelchair positioned near the bed (16). The wheelchair is positioned near the bed (16) to transfer the disabled user from bed (16) to the wheelchair and wheelchair to the bed (16).

For transfer from bed (16) to the wheel chair, user sits on the edge of the bed (16) and brings the wheel chair backwards, such that the caster wheels (2) are near the edge of the bed (16) and the drive wheels (1) are away in front. User rotates the seats (9) such that they are in open position (See FIG. 6) and are positioned on either side of the chassis (A). User raises or lowers the level of the half seats (9) and takes the half seats (9) to the level of top of the bed (16). The wheel chair is then pulled little more towards the bed (16), such that the caster wheels (2) go under the bed (16) and the vertical support members (5) are almost touching the edge of the bed (16). User then rotates the half seats (9) horizontally and brings them towards the user and below his buttocks by sliding seats just over the bed, touching the sheets of bed. When both the half seats have come fully under the buttocks of the user, user locks the tubular fixator (6) using friction knobs (8) to arrest movement of the seats (9). Locking pin (7) is inserted which pass through the receiving holes of vertical support members (5), to prevent accidental fall of the tubular fixator (6). User is now sitting on both of the half seats (9) which are in locked position. Wheel chair can now be wheeled away by user, by turning the drive wheels (1).

For transfer from wheel chair to bed (16), user brings the chair near to the bed and positions the half seats (9) such that the seats (9) are fully on top of the bed (16). The friction knob (8) on chair mounts (6) is then turned, to allow free movement of the half seat (9). The user sitting on the seat, rotates half seats (9) to horizontally slide over the bed, away from buttocks of the user. When the seats are clear from the buttocks, user is sitting on the bed. The wheel chair is pushed aside, and kept beside the bed (16) for future use.

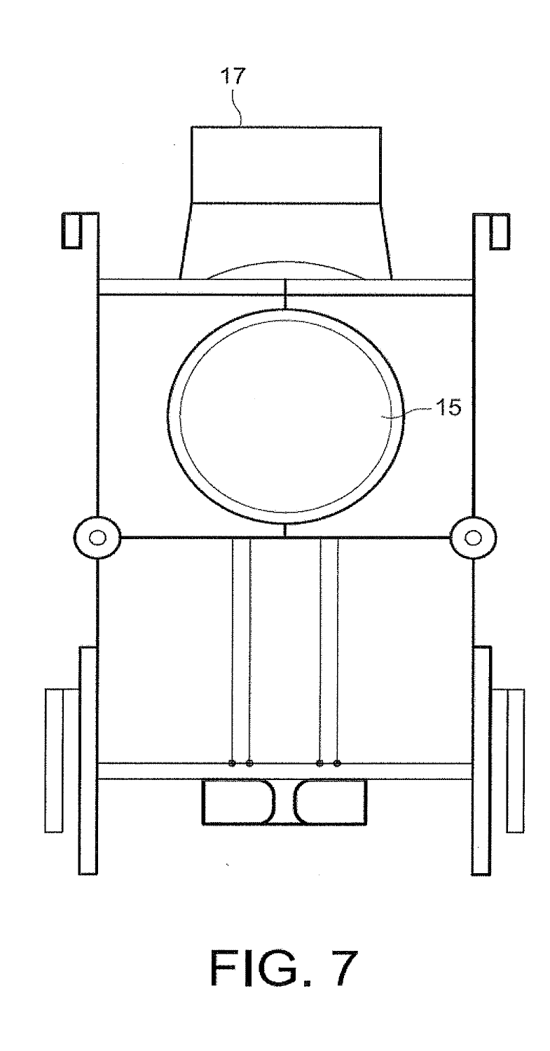

FIG. 7 is an exemplary embodiment of the disclosure and illustrates a top view of wheelchair, positioned above the commode. For toilet use, the user wheels the wheel chair near to the commode (17), and positions the half seats (9) directly above the commode (17). While sitting on the seats (9), user raises slightly his buttocks one by one and removes the removable strips (14) from half seats (9). User can now use the commode (17) sitting on the wheel chair which is directly on top of commode (17). After the use, the strips (14) are placed back on the half seats (9) in the slots.

In eases, where the disabled person is too weak or unable to use his hands to do the wheel chair transfer by himself, the wheel chair transfer has to be done by attendant.

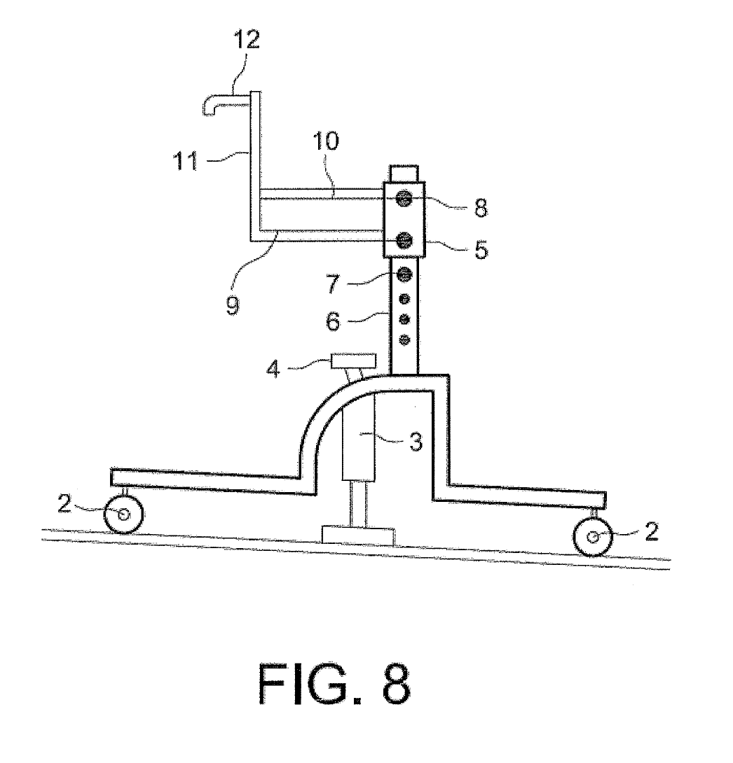

As another embodiment of the present disclosure, FIG. 8 illustrates side elevation view of wheelchair. The wheelchair comprises four caster wheels (2) designed for use by attendant which has all the capabilities of wheelchair as disclosed above and would be very useful for the attendant, as he does not have to lift the patient and carry patient's weight. All he has to do is to operate the wheelchair as described above, without bodily lifting and carrying the patient. Hence the chair transfer is quite safe and there is no possibility of injury to attendant or to the patient.

### ADVANTAGES

The present disclosure provides a wheelchair for paraplegics which is simple in construction, cost effective, easy maneuverability.

The present disclosure provides a wheelchair for paraplegics which particularly suits for paraplegics, which provides for easy and safe wheel chair transfer, enabling the disabled to do the transfer themselves without any help from attendant.

The present disclosure provides a wheelchair for paraplegics which has seats which will move and slide along the bed horizontally, to position the seats under the buttocks of the disabled, for transferring user in a safe and comfortable manner without need for helper.

### REFERENCE NUMERALS

| A | Chassis |
|---|---|
| 1 | Drive wheels |
| 2 | Caster wheels |
| 3 | Brake assembly |
| 4 | Brake handle |
| 5 | Vertical support member |
| 6 | Tubular fixator |
| 7 | Locking pin |
| 8 | Friction knobs |
| 9 | Seat |
| 10 | Armrest |
| 11 | Backrest |
| 12 | Handle |
| 13 | Footrest |
| 14 | Removable strips |
| 15 | Opening |
| 16 | Bed |
| 17 | Commode |

### EQUIVALENTS

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A wheelchair for transportation of disabled person, comprising:
a chassis;
plurality of wheels fixed to either end of chassis;
at least one vertical support member mounted at predetermined location on the chassis to support a least one tubular fixator;
a seat is joined to each of the tubular fixator which is pivoted onto the vertical support member; and
plurality of friction knobs are provided on the tubular fixator to lock the horizontal and vertical movement of tubular fixator.

2. A wheelchair as claimed in claim 1, wherein wheels at one end of the chassis are caster wheels.

3. A wheelchair as claimed in claim 1, wherein wheels at other end of the chassis are driving wheels.

4. A wheelchair as claimed in claim 1, wherein at least one brake assembly is connected to the chassis to stop movement of the wheelchair and lock the wheelchair in a place.

5. A wheelchair as claimed in claim 1, wherein the vertical support member is provided with plurality of holes along its length to accommodate a locking pin to restrict sliding of the tubular fixator along the vertical support.

6. A wheelchair as claimed in claim 1, wherein the tubular fixator and the vertical support members are concentric tubes, and said tubular fixator rotates horizontally and moves vertically on the vertical support members.

7. A wheelchair as claimed in claim 1, wherein the seat has an opening partially covered by plurality of removable strips placed in slots provided in the seat.

8. A wheelchair as claimed in claim 1, wherein the armrests are fixed to the seat for placing users arm.

9. A wheelchair as claimed in claim 1, wherein the seat comprises a back rest.

10. A wheelchair as claimed in claim 1, wherein plurality of handles are provided behind the backrest to push or pull the wheelchair by an attendant.

11. A wheelchair as claimed in claim 1, wherein footrests are provided to one end of chassis for resting user legs.

12. A wheelchair for transportation of disabled person, comprising:
a chassis;
plurality of wheels fixed to either end of chassis;
a pair of vertical support members mounted at predetermined location on the chassis to support a least one tubular fixator on each of the vertical support members;
a seat is joined to each of the tubular fixator which is pivoted onto the vertical support member wherein seat of each tubular fixator would form a single seat when the tubular fixator are rotated horizontally and
plurality of friction knobs are provided on each of the tubular fixator to lock the horizontal and vertical movement of tubular fixator.

13. A method of assembling a wheelchair, comprising;
connecting plurality of wheels to either end of chassis of the wheelchair;
mounting at least one vertical support member at predetermined location on the chassis to support at least one tubular fixator;
connecting a seat to each of the tubular fixator which is pivoted onto the vertical support member; and
connecting plurality of friction knobs on the tubular fixator to lock the horizontal and vertical movement of tubular fixator.
